(19) United States
(12) Patent Application Publication
(10) Pub. No.: US 2013/0124421 A1
(43) Pub. Date: May 16, 2013

(54) SECURE AUTHENTICATION METHOD AND SYSTEM FOR ONLINE TRANSACTIONS

(71) Applicant: Alibaba Group Holding Limited, George Town (KY)

(72) Inventor: Yuliang Deng, Hangzhou (CN)

(73) Assignee: ALIBABA GROUP HOLDING LIMITED, George Town (KY)

(21) Appl. No.: 13/666,671

(22) Filed: Nov. 1, 2012

(30) Foreign Application Priority Data
Nov. 4, 2011 (CN) 201110346508.3

(51) Int. Cl. G06Q 20/40

(52) U.S. Cl. CPC G06Q 20/401
USPC 705/71

(57) ABSTRACT

Embodiments of the invention relate to a secure authentication method for online transactions, an online transaction secure authentication system, an online transaction secure authentication client, and a computer program product for secure authentication of online transactions thereof. The secure authentication method includes: generating, using one or more computer processors, a random session key to encrypt communications between a client and a server; verifying a user identity of a user using the client based on the generated random session key; in the event that the verification of the user identity is successful, generating transaction image information, encrypting the transaction image information based on the random session key, and transmitting the encrypted transaction image information to the client; receiving a confirmation of the transaction image information, the confirmation comprising a transaction signature; and verifying the transaction signature based on the random session key.

### CROSS REFERENCE TO OTHER APPLICATIONS

This application claims priority to People's Republic of China Patent Application No. 201110346508.3 entitled A SECURE AUTHENTICATION METHOD AND SYSTEM FOR ONLINE TRANSACTIONS filed Nov. 4, 2011 which is incorporated herein by reference for all purposes.

### FIELD OF THE INVENTION

The present application relates to a secure authentication method and system for online transactions.

### BACKGROUND OF THE INVENTION

With the Internet developing and growing every day, online transactions have become an important way whereby people conduct their everyday business activities. However, online transactions typically require an Internet connection. Users typically need to input passwords through computers connected to the Internet during a transaction payment process. Passwords to user account may easily be exposed if a hacker attack were to occur during the transaction payment process, and users may consequently suffer economic losses.

Some forms of hacker attacks include phishing, Trojan horse, and Trojan phishing. Phishing refers to a method hackers use to obtain a user's password through deceitful means such as asking the user to send personal information to a fake email or website. Trojan horse refers to a method hackers use by planting a malicious program in a user's machine for the purpose of falsifying a user's transactions in such a way that the user ends up paying the bill on the behalf of the hackers. Trojan phishing refers to a method of simultaneously using a Trojan horse and phishing to accomplish the following: hijacking a user's transaction, creating the transaction on a third-party website, falsifying a display of the user's transaction, presenting the user with the transaction they wish to see, tricking the users into inputting their password, and causing the user to pay the bill on behalf of the hacker on the third-party website.

To increase the security of a transaction, password control techniques and dynamic password (one-time password, abbreviated as OTP, i.e., one password per occasion) techniques have been developed to improve protection of online transactions. However, the earliest password control technique was a static password protection plug-in, and the first-generation OTP techniques were designed only to improve password security but the OTP techniques provided little defense against phishing and Trojan horses. Second-generation OTP techniques generate passwords using transaction information as an external input. However, a generated password in this case is no longer secure based on password security. Consequently, security is improved, but the second-generation OTP techniques that are applied primarily rely hardware products, such as USB keys. However, the hardware products are subject to limitations with respect to both operating scope and service life. In particular, when technologies are upgraded, a hardware product generally needs to be upgraded with the introduction of new hardware technologies, as well.

Therefore, implementing a second-generation OTP technology without using hardware while defending against phishing, Trojan horses, and Trojan phishing is desired.

### BRIEF DESCRIPTION OF THE DRAWINGS

Various embodiments of the invention are disclosed in the following detailed description and the accompanying drawings.

FIG. 1 is a flow chart illustrating an embodiment of an online transaction secure authentication method.

FIG. 2 is a flow chart illustrating an embodiment of a process to generate a random session key to encrypt communications between a client and a server.

FIG. 3 is a flow chart illustrating an embodiment of a process of a user identity being verified using user machine information.

FIG. 4 is a flow chart illustrating an embodiment of a user identity being verified through a mobile phone short message.

FIG. 5 is a diagram illustrating an embodiment of contents of mobile phone short-message information.

FIG. 6 is a flow chart illustrating an embodiment of a process of acquiring transaction image information.

FIG. 7 is a diagram illustrating an example of transaction image information.

FIG. 8 is a flow chart illustrating an embodiment of a process of generating transaction image information.

FIG. 9 is a flow chart illustrating an embodiment of a process of verifying a transaction signature.

FIG. 10 is a flow chart illustrating an embodiment of a password control user being upgraded to an OTP control user.

FIG. 11 is a structural drawing illustrating an embodiment of an online transaction secure authentication system.

FIG. 12 is a structural diagram illustrating another embodiment of an online transaction secure authentication system.

FIG. 13 is a diagram illustrating an embodiment of a payment website being phished within the website.

FIG. 14 is a diagram illustrating an embodiment of a user being phished to a third-party external merchant.

FIG. 15 is a diagram illustrating an embodiment of a user being phished to a third-party payment platform.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In order that the above-stated objectives, features, and advantages of the present application may be more easily understood, the present application is explained in greater detail below in light of the attached drawings and specific embodiments.

The present application implements, in software form, a secure authentication method and system for online transaction that can both minimize the problems that a hardware product has with scope of operation, service, and technical upgrades and the problems that online transactions now face in defending against phishing, Trojan horses, and Trojan phishing.

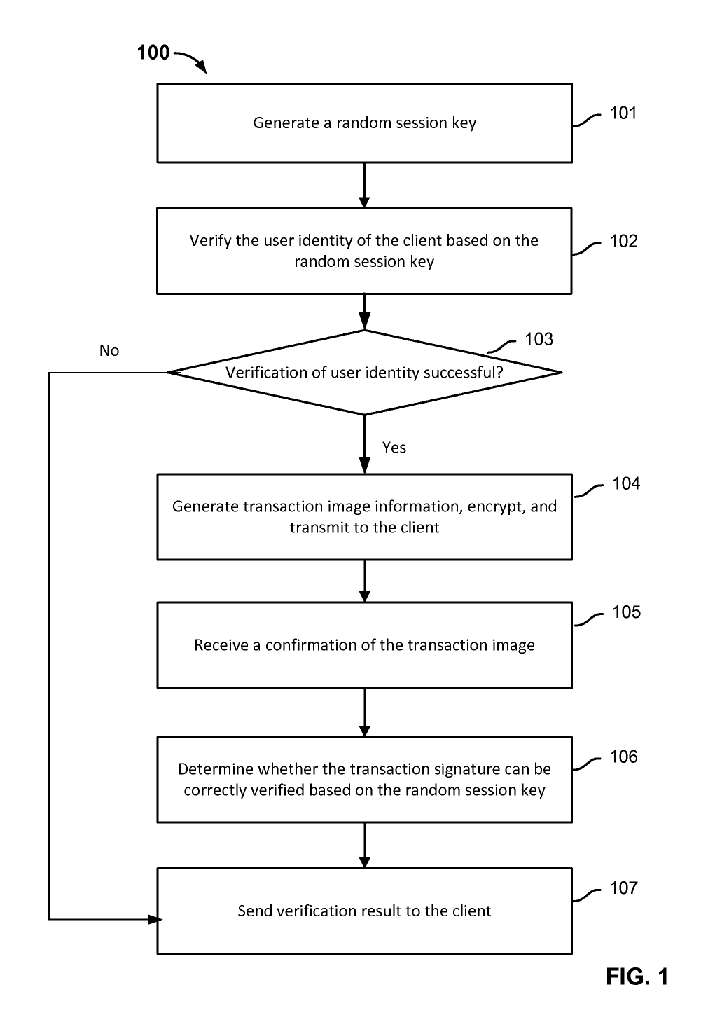

The processes of the present application shall be explained in detail below in light of FIGS. 1 through 9.

The processes of FIGS. 1 through 9 involve OTP controls, JavaScript (JS, which is a kind of computer script language), browsers located at the client, online payment gateways, OTP control servers (abbreviated as control servers in the figures), OTP authentication platforms, business systems, and server-side databases. The OTP controls are installed on client machines (e.g., personal computers, smartphones, tablets, or other appropriate devices) and function in cooperation with OTP control servers and OTP authentication platforms to complete secure authentication for online transactions. The OTP control servers primarily verify the user identity of an OTP control, and the OTP authentication platform primarily serves to complete transaction verification. Online payment secure sockets layer (SSL) servers complete online payments in an online transaction. Business systems primarily process data in the online transaction.

Referring to FIG. 1. FIG. 1 illustrates an embodiment of an online transaction secure authentication process for encrypted communication between a client and a server. The process can be performed on the server and requires the cooperation of the client. The process includes the following steps:

In step 101, the server generates a random session key.

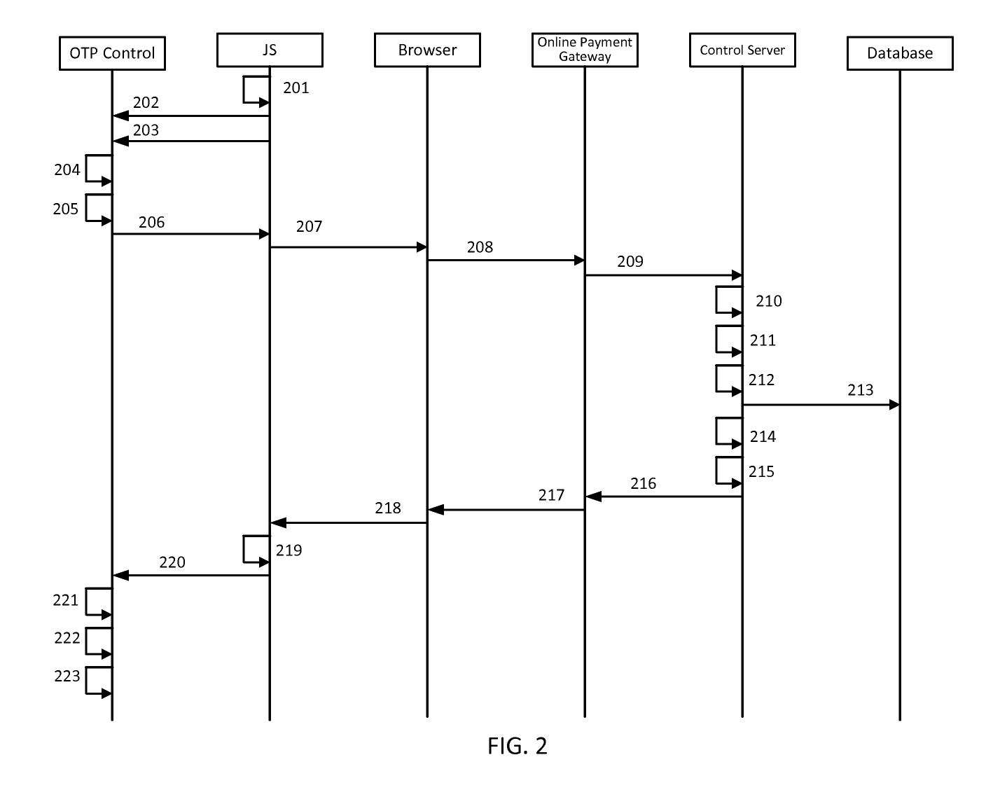

The generation of the random session key may include the client and the server exchanging random session keys. In some embodiments, the client generates a random number and sends the random number to the server; and the server generates a random session key and capture factors, and sends the random session key and the capture factors back to the client. Details of this step are described below in connection with FIG. 2.

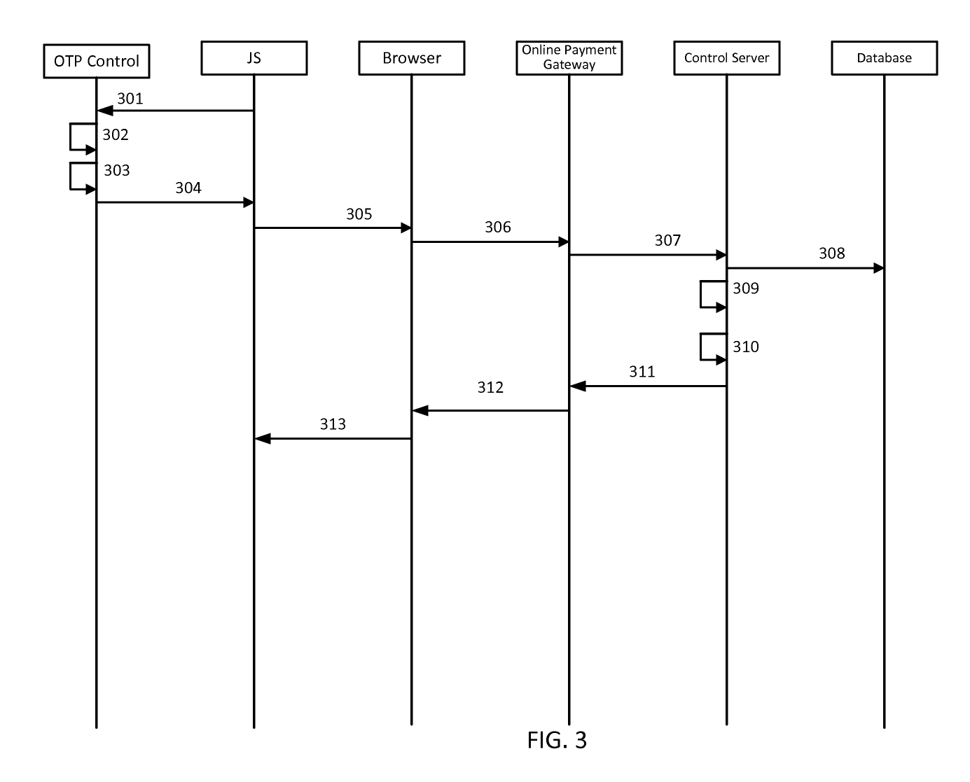

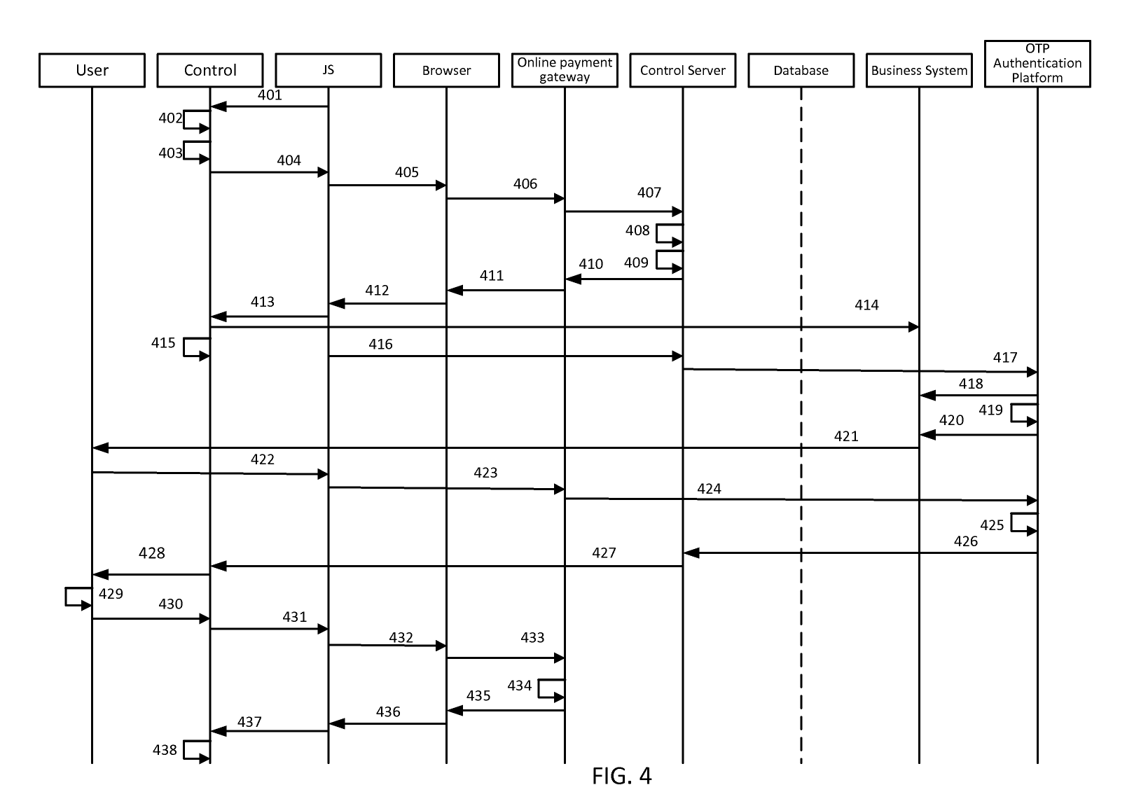

In step 102, the user identity of the client is verified based on the random session key. The verification of the client at this point prevents Trojan software from hijacking the session. Two verification approaches are described below in connection with FIGS. 3 and 4.

In step 103, it is determined whether the verification of user identity is successful. If the verification is successful, in step 104, transaction image information is generated, and the transaction image information is encrypted based on the random session key and transmitted to the client. Else, in step 107, a verification result is sent to the client indicating the status of the unsuccessful verification.

In step 105, confirmation of the transaction image is received. In some embodiments, the confirmation includes a transaction signature. In step 106, it is determined whether the transaction signature can be correctly verified based on the random session key. The verification result is sent to the client at step 107.

FIG. 2 illustrates an embodiment of a process to generate a random session key. Process 200 can be used to implement step 101 of process 100. The components involved in the process are illustrated on top of the diagram. The browser, JS, and OTP control are on the client side; the online payment gateway, control server, and database are on the server side. The process includes the following steps:

In step 201, the user is ready to checkout, and thus the webpage transfers to the checkout page.

In step 202, the Javascript (JS) initializes the OTP control.

In step 203, the JS generates a random session key request and sends the random session key request to the OTP control.

In step 204, the OTP control generates a random number. For example, the random number may be a 24-byte random number.

In step 205, the OTP control uses a preset RSA public key to encrypt the generated random number. RSA is a public key encryption algorithm well known in the art.

In step 206, the OTP control sends the encrypted random number back to the JS.

In step 207, the JS invokes the browser to send a session key exchange request.

In step 208, the browser sends the session key exchange request to the online payment gateway.

In step 209, the online payment gateway forwards a message to the OTP control server.

The forwarded message includes the session key exchange request.

In step 210, the OTP control server decrypts the message and acquires the random number generated by the OTP control.

For example, the OTP control server decrypts the message to obtain the 24-byte random number of the OTP control based on an RSA private key.

In step 211, the OTP control server generates a random number. For example, the random number may be a 12-byte random number.

In step 212, the OTP control server combines random number it generated and the random number sent by the OTP control on the client. For example, the OTP control server can combine the first 12 bytes of the 24 byte random number of the OTP control with the 12 byte random number of the OTP control server to generate a 24-byte random session key.

In step 213, the OTP control server stores the 24 byte random session key in a database.

In step 214, the OTP control server generates capture factors.

For example, the capture factors may include a set of N random numbers that are selected at random and the set of random numbers are used in step 102 to capture user machine information and to verify the captured user machine information. N may be any positive integer.

In step 215, the OTP control server encrypts both the 12-byte random number and the capture factors based on the 24-byte random number of the OTP control.

In step 216, the OTP control server sends a session key exchange response to the online payment gateway.

In step 217, the online payment gateway forwards the session key exchange response to the browser.

In step 218, the browser receives the session key exchange response and sends the session key exchange response to the JS, which is invoked.

In step 219, the JS receives the encrypted information including the 12-byte random number and the capture factors.

In step 220, the JS sends a machine information verification request including the encrypted information to the OTP control.

In step 221, the OTP control decrypts the encrypted information based on the 24-byte random number that it generated to obtain the 12-byte random number of the OTP control server.

In step 222, the OTP control uses the first 12 bytes of the 24 byte random number that it generated and the decrypted 12 byte random number generated by the OTP control server to obtain the random session key. Subsequent messages may be encrypted based on the random session key.

In step 223, the OTP control also acquires the capture factors from the encrypted information. As discussed above, a random session key is generated between the OTP control and the OTP control server, and each of the OTP control and the OTP control server generates one half of the random session key. Consequently, the random session key is highly secure.

Referring to 102 of FIG. 1, the verification of the user identity of the client includes at least two approaches. In one approach, the verification may be carried out using user machine information, as shown in FIG. 3. In another approach, the user identity of the client may be verified using a mobile phone short message, as shown in FIG. 4.

FIG. 3 illustrates an embodiment of a process of verifying user identity using user machine information. Process 300 can be used to implement step 102 of process 100, after the random session key is generated. Process 300 includes the steps below:

In step 301, the JS transmits a session key response message including a random session key and capture factors to the OTP control.

In step 302, the OTP control acquires the random session key and the capture factors from the received session key response message.

The OTP control uses the 24 byte random number that it generated to decrypt the session key response message and uses the decrypted 12 byte random number of the OTP control server to substitute for the last 12 bytes of the 24 byte random number that it generate. Accordingly, the OTP control obtains the random session key.

In step 303, the OTP control extracts user machine information.

The OTP control extracts the user machine information based on the capture factors. In some embodiments, the capture factors correspond with random numbers, and each number corresponds with a different part of the machine information. Each of the capture factors is associated with a part of the user machine information. In one example, the capture factors may include 10 random numbers. In this example, the capture factors are associated with parts of the user machine information corresponding to the 10 random numbers, and information associated with the parts of the user machine information are extracted. The OTP control may extract a different portion of the user machine information each time.

Because the capture factors are random, the user machine information extracted each time based on the capture factors also vary. For example, the capture factors issued at one time by the control server may be 16 random numbers, and the capture factors issued at another time may be 20 random numbers. In this example, the user machine information extracted may vary each time with respect to the same OTP control and the same user machine. Accordingly, the security of a verification of user identity may be increased. The user machine information may include hardware information of the machine, software information, operating system version, and the like. An example of the user machine information is media access control (MAC) address, CPU serial number, hard drive serial number, software information (operating system version and major application versions), etc. However, there are many other possibilities and combinations. The same piece of user machine information will not change for the duration of the session.

In step 304, the OTP control encrypts the user machine information based on the random session key and sends the encrypted user machine information back to the JS.

In response to the above described capture factor method being employed, the OTP control may encrypt and send the capture factors together with the user machine information.

In step 305, the JS invokes the browser to send a request message. The request message may include the user machine information and the capture factors.

In step 306, the browser sends the request message to the online payment gateway.

In step 307, the online payment gateway forwards the request message to the OTP control server.

In step 308, the OTP control server retrieves information from the database. In some embodiments, the database stores predetermined machine information of various clients. Subsequently, based on the capture factors provided to the database, various machine information corresponding to the capture factors for a particular client may be requested from the database.

In step 309, the OTP control server compares the information from the database related to the capture factors with the extracted user machine information. The OTP control server compares each part of the user machine information with the information from the database to determine whether there is a match.

The OTP control server conducts a comparison of the extracted user machine information corresponding to the capture factors and the information corresponding to the capture factors in the database to determine whether the extracted user machine information is different from what is stored in the database.

In step 310, in the event the match success rate of the user machine information exceeds a defined threshold, the OTP control server verifies that the user machine information is successfully matched.

The predefined threshold may be greater than or equal to 80% in order for the OTP server to verify the user machine information is successfully matched. In response to the user machine information match success rate being less than 80%, the OTP server verifies that the user machine information is unsuccessfully matched.

In step 311, the OTP control server sends the match result back to the online payment gateway.

In step 312, the online payment gateway forwards the match result to the browser.

In step 313, the browser receives the match results and sends the match result back to the JS, which is invoked to display a successful transaction if the match result indicates success, or a failed transaction/warning message if the match result indicates failure.

Referring to FIG. 4, FIG. 4 illustrates an embodiment of a process of verifying a user identity using a mobile phone short message, as discussed below:

In FIG. 4, steps 401 through 409 are substantially similar to steps 301 through 309 of FIG. 3, and thus, a description of steps 401 through 409 are omitted for conciseness.

In step 410, in response to the user machine information match success rate failing to exceed the predefined threshold, the user identity is determined to be unsuccessfully matched.

As stated above, in to the event the user machine information match success rate fails to exceed 80%, the user identity verification is a failure.

In step 411, the OTP control server sends a message indicating that the user identity verification was unsuccessful back to the online payment gateway.

In step 412, the online payment gateway forwards the message indicating that the user identity verification was unsuccessful to the browser.

In step 413, the browser receives the message indicating that the user identity verification was unsuccessful and sends the message back to the JS, which is invoked.

In step 414, the JS retrieves a short message verification code verification page.

In step 415, the JS displays the short message verification code verification page.

Generally, the short message verification code verification page prompts the user to input a mobile phone number or other user-related information.

In step 416, the JS sends a short-message send request to the OTP control server.

After the user inputs the user's mobile phone number or other user-related information into the short message verification code verification page, the JS sends a short-message send request to the user.

In step 417, the control server sends the short-message send request to the OTP authentication platform.

In step 418, the OTP authentication platform retrieves user information from the business system, which would have stored user information previously (e.g., at the time the user registered an account). The user information may include a mobile phone number, a username, an e-mail address, a contact address, or other user-related information.

In step 419, the OTP authentication platform generates a verification code. The OTP authentication platform generates the verification code based on the user information.

In step 420, the OTP authentication platform sends a short-message send request to the business system.

In step 421, the business system sends a short message to a mobile phone registered by the user.

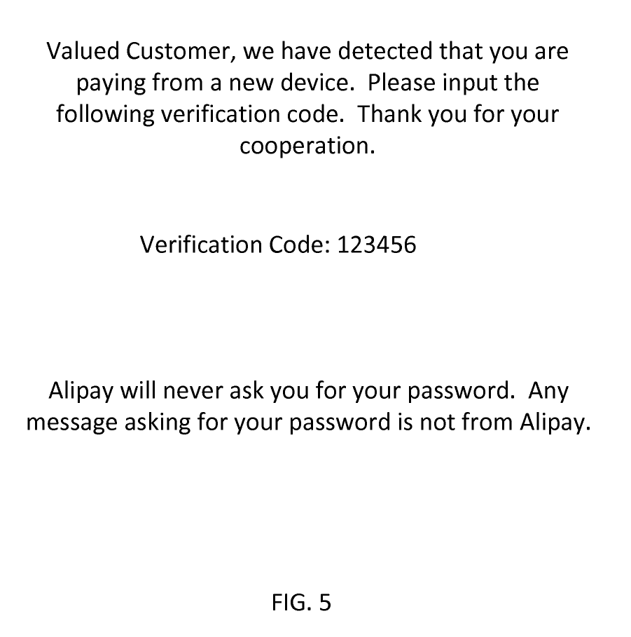

The short message includes the verification code generated by the OTP authentication platform. FIG. 5 illustrates an example of the contents of information of the short message displayed in a mobile phone.

In step 422, after the user receives the short message, the user inputs the verification code included in the short-message in the webpage, at the prompted location.

In step 423, the JS sends a short-message verification request to the OTP control server. The short-message verification request includes the user inputted verification code.

In step 424, the OTP control server forwards the short-message verification request to the OTP authentication platform.

In step 425, the OTP authentication platform verifies the verification code included in the verification message.

In step 426, in to the event the verification is successful, the OTP authentication platform sends a verification successful response to the OTP control server.

In step 427, the OTP control server sends the verification successful response to the JS.

In step 428, the JS sends a capture machine information request to the OTP control.

In step 429, the OTP control captures all machine information of the user machine.

In step 430, the OTP control sends the captured machine information back to the JS.

The OTP control encrypts the machine information based on a random session key.

In step 431, the JS invokes the browser to submit the captured machine information.

In step 432, the browser sends a request message including the captured machine information to the online payment gateway.

In step 433, the online payment gateway forwards the request message to the OTP control server.

In step 434, the OTP control server updates the user machine information.

In step 435, the OTP control server sends a response message to the online payment gateway.

In step 436, the online payment gateway forwards the response message to the browser.

In step 437, the browser invokes the JS and sends back the response message to the JS.

In step 438, the JS receives the response message and completes the user identity verification.

Referring again to FIG. 1, step 103, after verification of user identity is successful, generate transaction image information and encrypt the transaction image information based on the random session key and transmit the transaction image information to the client.

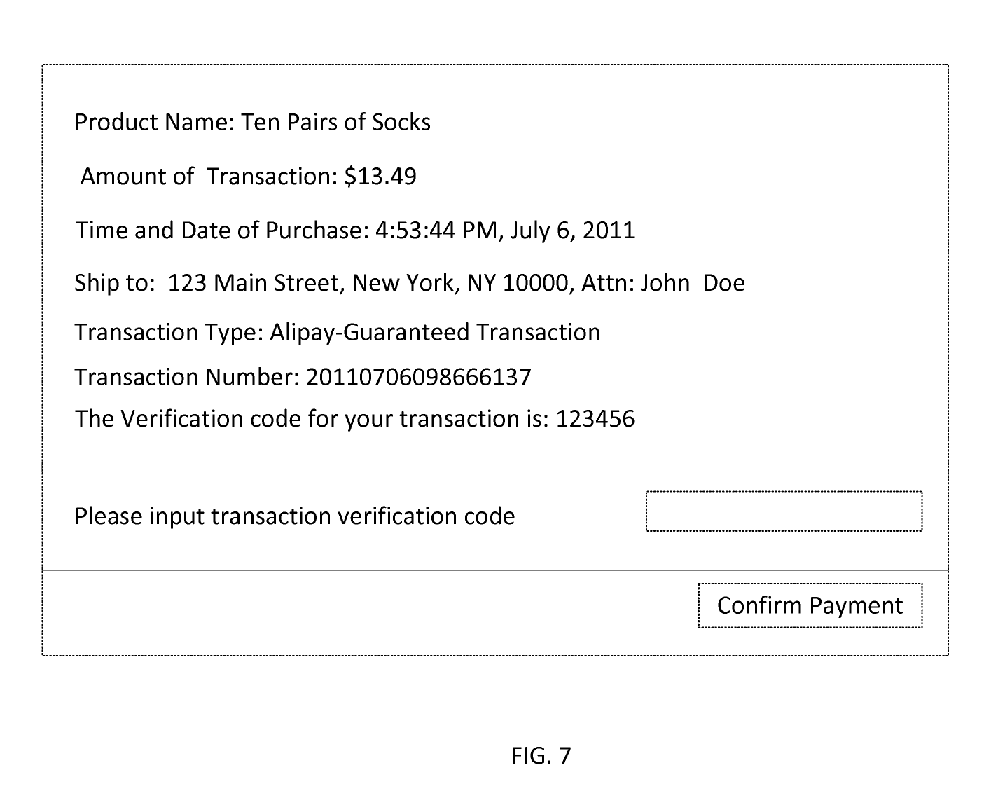

The server may generate the transaction image information. FIG. 7 illustrates an example of transaction image information. In addition, the server may send the transaction image information to the client.

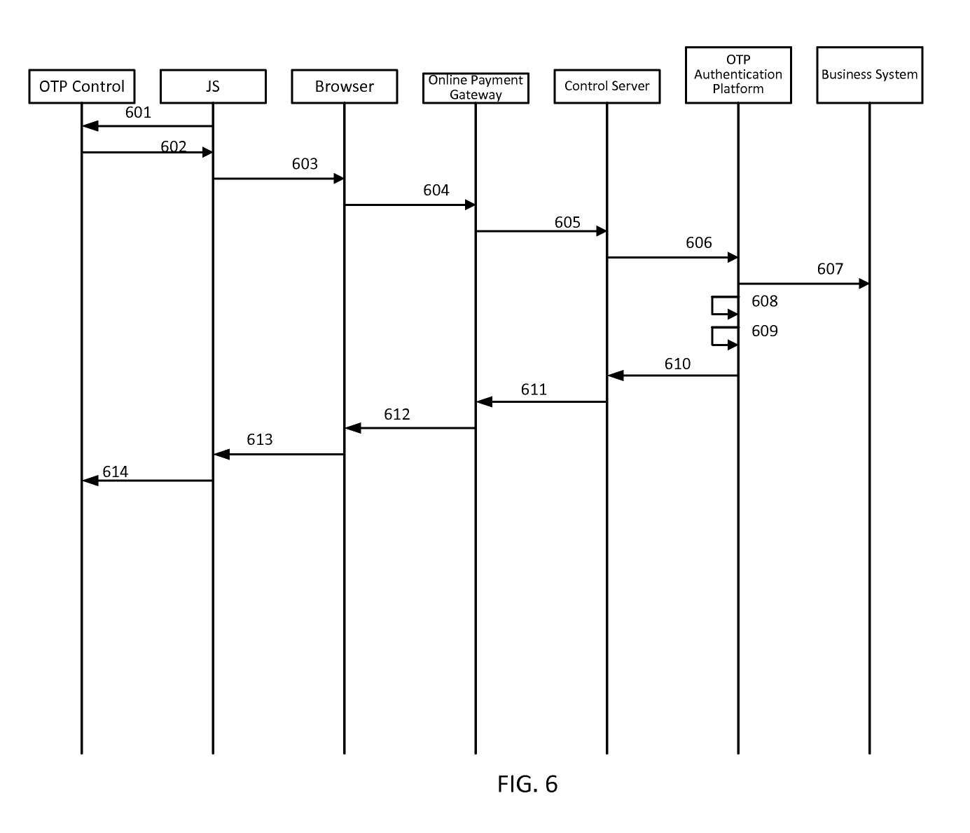

Referring to FIG. 6, FIG. 6 illustrates a process of the client acquiring transaction image information. The process is discussed below:

In step 601, the JS sends user machine information verification results to the OTP control.

In response to the machine verification being unsuccessful, the mobile phone short-message verification approach may be adopted. Accordingly, mobile phone short-message verification results may be sent to the OTP control.

In step 602, the OTP control sends a transaction image information request to the JS.

In step 603, the JS sends the transaction image information request to the browser.

In step 604, the browser sends the transaction image information request to the online payment gateway.

In step 605, the online payment gateway forwards the transaction image information request to the OTP control server.

In step 606, the control server sends the transaction image information request to the OTP authentication platform.

In step 607, the OTP authentication platform retrieves transaction information from a business system based on an order number.

The OTP authentication platform acquires the order number corresponding to the transaction image information request from the business system and acquires the corresponding transaction information based on the order number. The transaction information may include the content of the transaction, the monetary value of the transaction or amount of the transaction, and the time of the transaction, and other information related to the transaction, as shown in FIG. 7.

In step 608, the OTP authentication platform generates image elements based on the transaction information.

The image elements may refer to elements such as, for example, the transaction verification code, summary information, and base image. The image elements may be used to generate the transaction image information.

In step 609, the OTP authentication platform generates the transaction image information.

The OTP authentication platform may include an image server configured to use the image elements to generate the transaction image information.

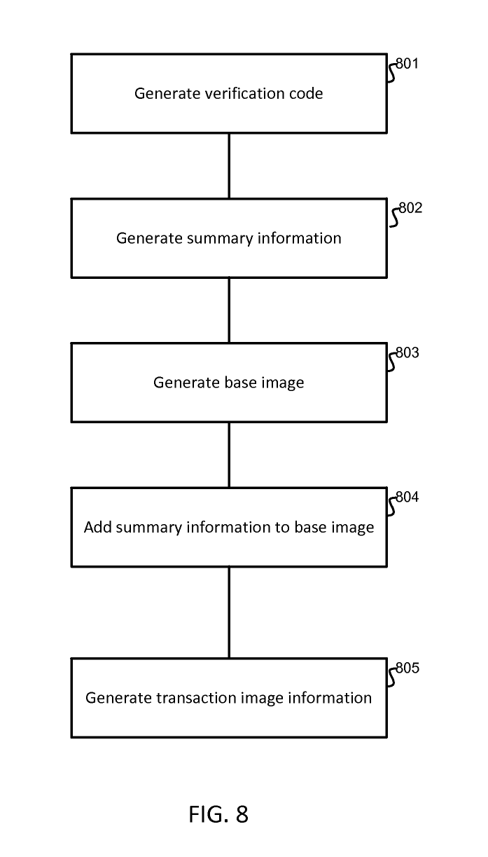

FIG. 8 illustrates an embodiment of a process of generating transaction image information in steps 608 and 609.

In step 610, the OTP authentication platform encrypts the transaction image information based on the random session key and sends the encrypted transaction image information to the OTP control server.

In step 611, the OTP control server sends the transaction image information to the online payment gateway.

In step 612, the online payment gateway forwards the transaction image information to the browser.

In step 613, the browser receives the transaction image information and sends the transaction image information back to the JS, which is invoked.

In step 614, the JS displays the transaction image information to the OTP control.

Referring to FIG. 8, FIG. 8 illustrates an embodiment of a process of generating transaction image information on the OTP authentication platform. The process comprises the following steps:

In step 801, an OTP algorithm driving module generates a transaction verification code based on transaction information, a random session key, time, and a user seed.

In some embodiments, the time refers to transaction time, and the user seed refers to a random number (e.g., a 20-byte random number). A unique user seed may be assigned to each user.

In step 802, the OTP business system generates summary information based on the transaction information and the random session key. Each transaction has unique summary information.

In step 803, the image server generates a base image.

In step 804, the summary information is added to the base image. The summary information and the base image may have the same color.

In step 805, the transaction information and the transaction verification code are added to the base image including the summary information. The transaction image information corresponds to the base image containing the summary information after the transaction information and the transaction verification code have been added. Accordingly, the transaction image information is generated.

Referring to FIG. 1, in steps 105 and 106, the client sends a confirmation of the transaction image information, and in response, the server verifies a transaction signature based on the random session key.

When the user acquires the transaction image information, he may acquire the transaction verification code from the transaction image information and input the transaction verification code to confirm the transaction. The OTP control digitally signs the transaction image information and the transaction verification code based on the random session key, creating a transaction signature and sends the transaction signature to the OTP authentication platform as a confirmation. The OTP authentication platform verifies whether the transaction signature is correct and sends the verification result back to the client.

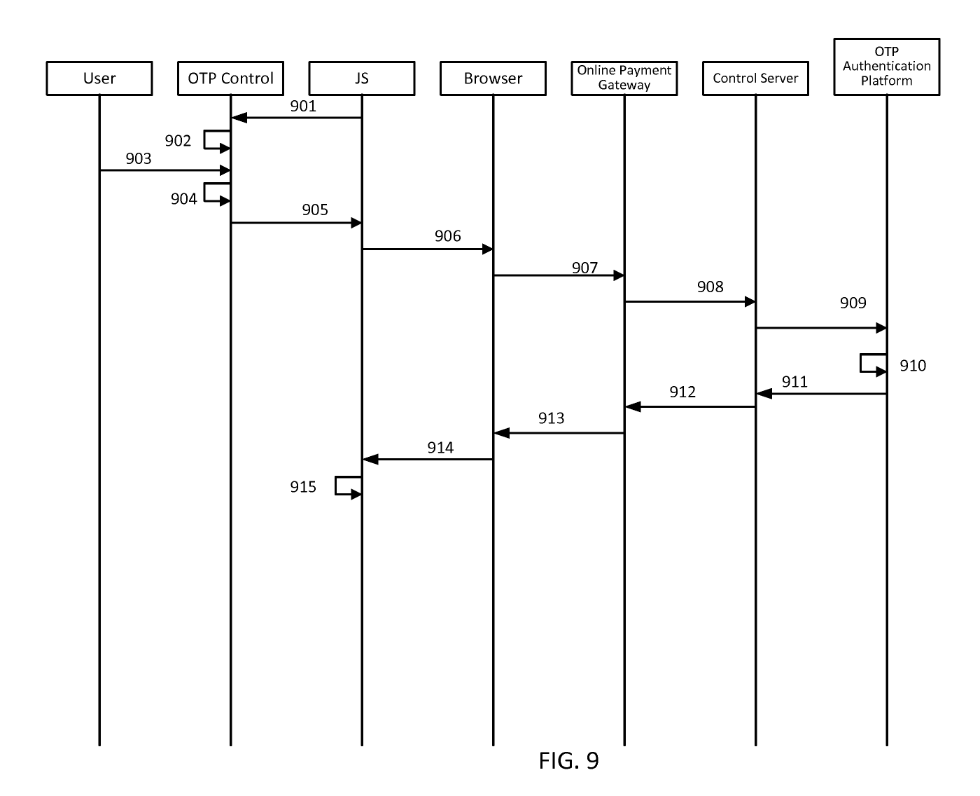

FIG. 9 illustrates an embodiment of a process of verifying the transaction signature. Referring to FIG. 9, FIG. 9 includes the following steps:

In step 901, the JS sends a transaction image information display request to the OTP control.

In step 902, the OTP control displays the transaction image information. FIG. 7 illustrates an example of displayed transaction image information.

In step 903, the user inputs the transaction verification code at the OTP control.

In step 904, the OTP control digitally signs the transaction image and the transaction verification code based on the random session key to create a transaction signature.

In step 905, the OTP control sends a signature verification request including the transaction signature to the JS.

In step 906, the JS sends the signature verification request to the browser.

In step 907, the browser sends the signature verification request to the online payment gateway.

In step 908, the online payment gateway forwards the signature verification request to the OTP control server.

In step 909, the OTP control server sends the signature verification request to the OTP authentication platform.

In step 910, the OTP authentication platform verifies whether the transaction signature is correct.

In step 911, the OTP authentication platform sends signature verification results to the OTP control server.

In step 912, the OTP control server sends the signature verification results to the online payment gateway.

In step 913, the online payment gateway forwards the signature verification results to the browser.

In step 914, the browser receives the signature verification results and sends the signature verification results back to the JS, which is invoked.

In step 915, the JS performs follow-up processing.

The fact that the above discussed secure authentication process adds a random session key to the transmission process ensures that the transaction image information will not be falsified in any part of the transmission process. Also, the transaction image information may be displayed in the control. As the user inputs the password (or transaction verification code), the control digitally signs the transaction image information and password based on the random session key, and transmits the transaction image information and password to the OTP control server for verification. Thus, the security of the entire transaction process is ensured.

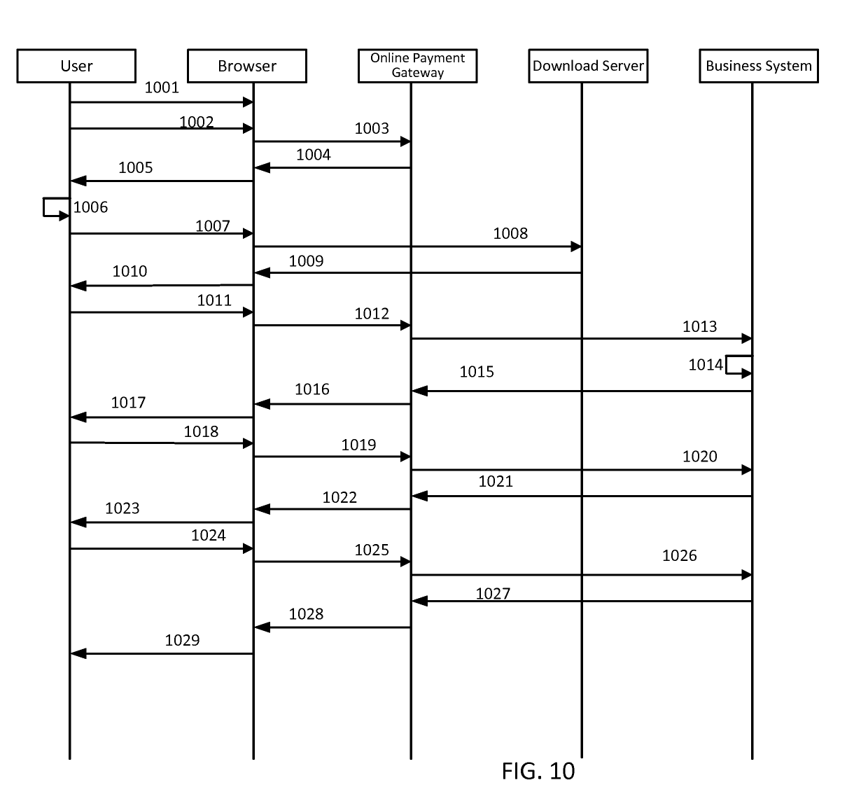

The user referred to above is the OTP control user. The OTP control user is a user who has installed an OTP control and who has undergone real name authentication and mobile phone binding (i.e., his mobile phone is linked to his account). FIG. 10 illustrates an embodiment of a password control user being upgraded to an OTP control user. Referring to FIG. 10, the process of upgrading to the OTP control user includes the following steps:

The user opens the browser (1001) and inputs the payment website address or payment uniform resource locator (URL) into the browser (1002). The browser requests upgrade information from the online payment gateway (1003). The online payment gateway sends a script to the browser including an upgrade prompt (1004). The browser displays the upgrade prompt (1005). The user views the upgrade prompt displayed by the browser (1006). The user clicks on or activates the upgrade prompt displayed by the browser (1007). The browser transmits a download request to a download server (1008). The download server transmits the upgrade information to the browser (1009). The user installs the upgrade information from the browser (1010). At the first payment after the user installs the upgrade information (1011), the browser sends a request message to the online payment gateway (1012). The online payment gateway retrieves the user type from the business system (1013). The business system determines whether the real name of the user has been authenticated (1014). In response to the real name of the user not having been authenticated, the business system sends back a page requesting real-name authentication to the online payment gateway (1015). The online payment gateway sends back a real-name authentication page to the browser (1016), and the browser displays the real-name authentication page to the user (1017). The user enters identity information and bank card information into the browser (1018), and the browser sends the identity information and the bank card information to the online payment gateway (1019). The online payment gateway verifies the identity of the user and upon verification of the identity of the user, releases funds for payment to the business system (1020). The business system sends a payment release message to the online payment gateway (1021), and the online payment gateway forwards the payment release message to the browser (1022). The browser displays the payment release message to the user (1023). The user inputs payment release information and mobile phone information to the browser (1024). The browser sends a verification request to the online payment gateway (1025). The online payment gateway forwards the verification request to the business system (1026). The business system sends a verification result back to the online payment gateway (1027). The online payment gateway sends the verification result to the browser (1028). The browser displays the verification result to the user (1029).

Thus, for new applications, users, upon being registered, are upgraded to being an OTP control user based on the process illustrated in FIG. 10.

In addition, in the user identity verification process of step 102, the server first uses user machine information to verify the user's identity. In response to user identity verification failing, the server may then verify the user's identity using the mobile phone short-message verification approach. Therefore, mobile phone numbers related to users are important for secure payments. Thus, one of the two methods described below needs to be employed in order to change a mobile phone number related to a user:

One method for changing the mobile phone number related to the user includes the following steps: sending an email to an email address related to the user. The user verifies their identity via a link included in the email and then the user updates their mobile phone number.

The other method for changing the mobile phone number related to the user includes updating the mobile phone number after the user verifies his or her identity by calling customer service.

The present application also provides system embodiments that correspond to the above described method embodiments.

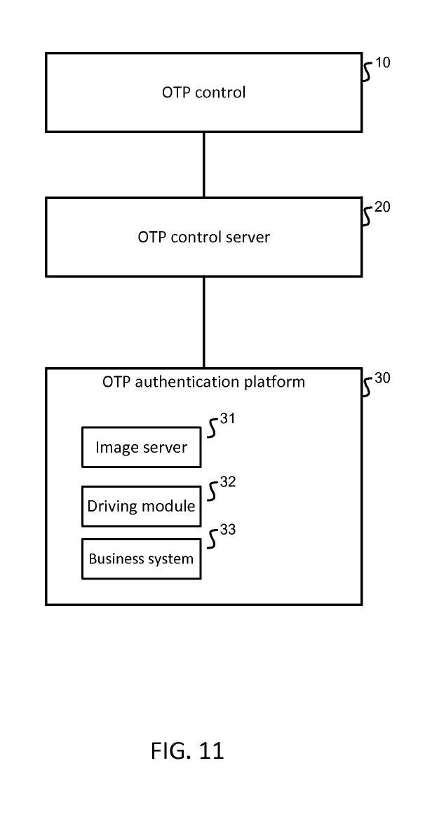

FIG. 11 illustrates an embodiment of an online transaction secure authentication system.

Referring to FIG. 11, FIG. 11 illustrates an embodiment of an online secure authentication system including an OTP control 10, an OTP control server 20, and an OTP authentication platform 30, wherein:

The OTP control 10 and OTP control server 20 are configured to generate random session keys for encrypting communications between the OTP control 10 and the OTP control server 20 and verifying the user identity of the OTP control 10 based on the random session key.

The OTP authentication platform 30 is connected to the OTP control server 20 and is configured to generate transaction image information after receiving a user identity verification successful message sent by the OTP control server 20. The OTP authentication platform 30 encrypts the transaction image information based on a random session key and transmits the transaction image information to the OTP control 10. After the OTP control 10 confirms the transaction image information, the OTP control server 20 verifies the transaction signature based on another random session key.

In response to the random session key being generated in the process discussed above, the OTP control 10 generates a random number, encrypts the random number based on a preset RSA public key, and sends the encrypted random number to the OTP control server 20. The OTP control server 20 generates the other random session key based on the encrypted random number and sends the other random session key to the OTP control 10.

In response to the OTP control's user identity being verified in the above process, the OTP control 10 extracts user machine information, encrypt the user machine information based on the random session key, and sends the encrypted user machine information to the OTP control server 20. The OTP control server 20 determines a match level of the user machine information. In response to the user machine information match level exceeding a predefined threshold, the OTP control server 20 determines that user identity is successfully verified. In response to the user machine information match level failing to exceed the predefined threshold, the OTP control server 20 determines that user identity is unsuccessfully verified.

In another example, the OTP control server 20 may generate capture factors and send the capture factors to the OTP control 10. Subsequently, the OTP control 10 may extract the user machine information based on the capture factors, encrypt the user machine information and the capture factors based on the other random session key, and send the user machine information and the capture factors to the OTP control server 20. The OTP control server 20 may verify the match level of the user machine information based on the capture factors.

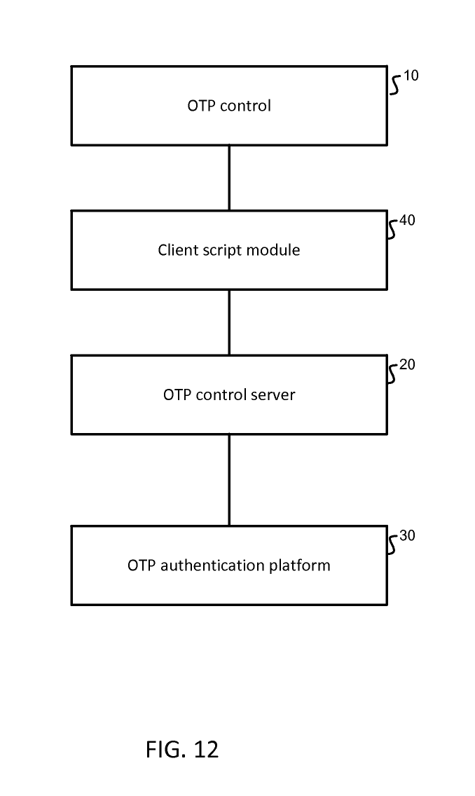

In another embodiment, as shown in FIG. 12, in the event the above-described user identity verification fails, the system may further comprise:

a client script module 40 configured to send a mobile phone short-message send request.

The OTP authentication platform 30 may also be configured to after receiving the mobile phone short-message send request, acquire user information, generate a mobile phone short-message verification code, and send the mobile phone short-message verification code to a mobile phone related to the user.

After receiving the mobile phone short-message verification code, the user inputs the mobile short-message verification code into the client script module 40 and sends the mobile short-message verification code to the OTP authentication platform 30.

The OTP authentication platform 30 may also be configured to verify the mobile phone short-message verification code. In response to a successful verification of the mobile phone short-message verification code, the OTP authentication platform 30 may send a user identity verification successful result to the client script module 40.

In another example, the OTP authentication platform 30 may further comprise:

An OTP algorithm driving module 32 configured to generate a transaction verification code based on transaction information, the random session key, time, and the user seed.

An OTP business system 33 configured to generate summary information based on the transaction information and the random session key.

An image server 31 configured to generate a base image and add the summary information to the base image, and add the transaction information and transaction verification code to the base image containing the summary information to generate transaction image information.

In response to verifying the transaction signature based on the above process, the OTP control 10 is configured to input the transaction verification code, digitally sign the transaction image information to create a transaction signature and the transaction verification code using the random session key to create the transaction signature, and send the transaction signature to the OTP authentication platform 30.

The OTP authentication platform 30 is configured to verify whether the transaction signature is correct and send verification results to the OTP control 10.

Because the secure authentication system embodiments are fundamentally similar to the method embodiments, their descriptions are kept relatively simple for conciseness. Descriptions of portions of the method embodiments may be used to explain corresponding portions of the system embodiments.

To aid comprehension of the present application, a few examples of hacker attacks are provided below to illustrate how the methods and systems provided by the present application can prevent phishing, Trojan horses, and Trojan phishing.

1. Intra-Site Phishing at Payment Websites

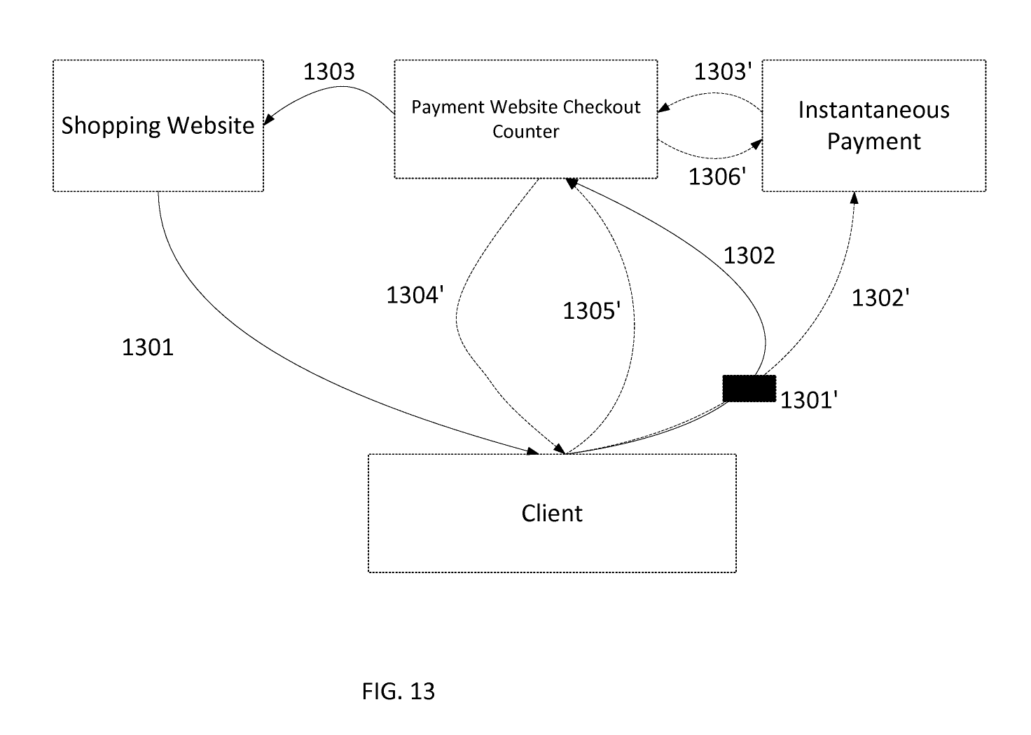

Referring to FIG. 13, normally, after selecting products that a client would like to purchase, the shopping website presents the client with a checkout counter (e.g., a webpage comprising a checkout facility) (1301). The client pays at the checkout counter an amount associated with the selected products (1302). The checkout counter forwards the payment to the shopping website (1303). However, such a transaction is subject to intra-site transaction substitutions, which is a mutant form of Trojan horse viruses software that have recently appeared. The Trojan horse virus software creates an instantaneous payment transaction within the payment website, for example, “I want to pay,” and then the payment website jumps to the checkout counter and lets the user pay.

An example of an intra-site transaction substitution process is also shown in FIG. 13:

In step 1301′, after purchasing a product on a shopping website, the user clicks to confirm the purchase. After the browser goes to a payment website checkout counter at the shopping website, the Trojan horse intercepts the normal payment process by, for example, monitoring the URL field of the browser.

In step 1302′, the Trojan horse redirects the browser to an instantaneous payment page of a payment website.

In step 1303′, the Trojan horse generates an “I want to pay” order. The payee or recipient of the payment is the online payment account of a swindler.

In step 1304′, the browser jumps to the payment website checkout counter. The user sees that he or she now needs to pay to complete an order. However, instead of making a payment to the shopping website to the legitimate seller, the order will instead make a payment to the online payment account of the swindler.

In step 1305′, the user authorizes the payment.

In step 1306′, the user pays the instantaneous payment order generated by the Trojan horse. The phishing process ends.

In the present application, the transaction information of the user is transmitted in the form of an image into an control for display. In addition, the entire process is encrypted by the random session key. The random session key may encrypt data at the application layer. Even if a hacker creates a new transaction, the hacker will not be able to transmit the image of this transaction into the control because the random session key of each control is different. The hacker's image cannot be decrypted using the random session key of the user's control.

2. Phishing to a Third-Party External Merchant

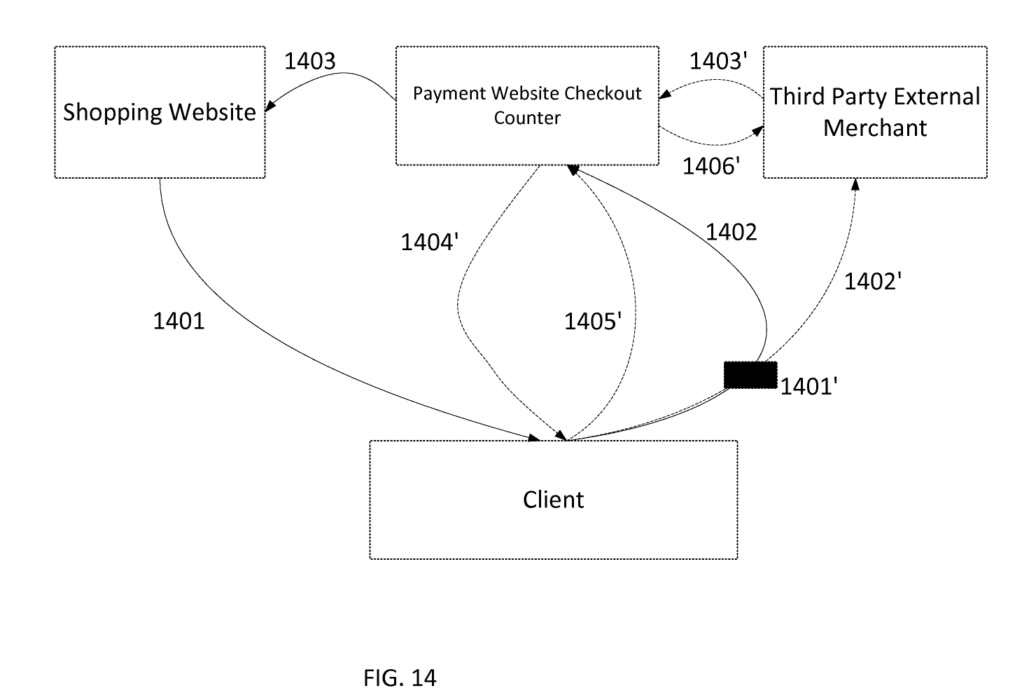

Referring to FIG. 14, for normal transactions, steps 1301, 1302 and 1303 of FIG. 13 correspond with steps 1401, 1402 and 1403 of FIG. 14. Thus, detailed explanations of steps 1401, 1402 and 1403 are omitted for conciseness. FIG. 14 illustrates the steps involved in the phishing to a third-party external merchant:

In step 1401′, after the user machine is infected with the Trojan horse, the Trojan horse will monitor the URL address field of the browser. After the user purchases a product at the shopping website, the user clicks on “Confirm Purchase.”

In step 1402′, instead of the browser jumping to the payment website checkout counter, the Trojan horse will intercept the normal payment process and redirect the browser to another third-party external merchant.

In step 1403′, the Trojan horse enters the swindler's external merchant account number at the client. The third-party external merchant then generates an order of the same amount. This order is paid using the payment website.

In step 1404′, the browser jumps to a payment website checkout counter. At this point, the user sees that he or she now needs to pay an order. However, payment of this order will go to the swindler's external merchant account.

In step 1405′, the user selects make a payment on the payment website checkout counter.

In step 1406′, the user pays the third party external merchant for the order. The payment website will make a payment to the third-party external merchant. The phishing process ends.

As can be seen from the phishing process above, this type of Trojan phishing is not only related to payment website security, but is also closely related to the security of the phished third-party external merchant. A great majority of external merchants do not have sound security systems for online transaction. If one could apply the solutions of the present application to third-party external merchants, such Trojan horses could be prevented. For example, the approach where the payment website provides client controls and server services could be used to prevent phishing.

3. Phishing to a Third-Party Payment Platform

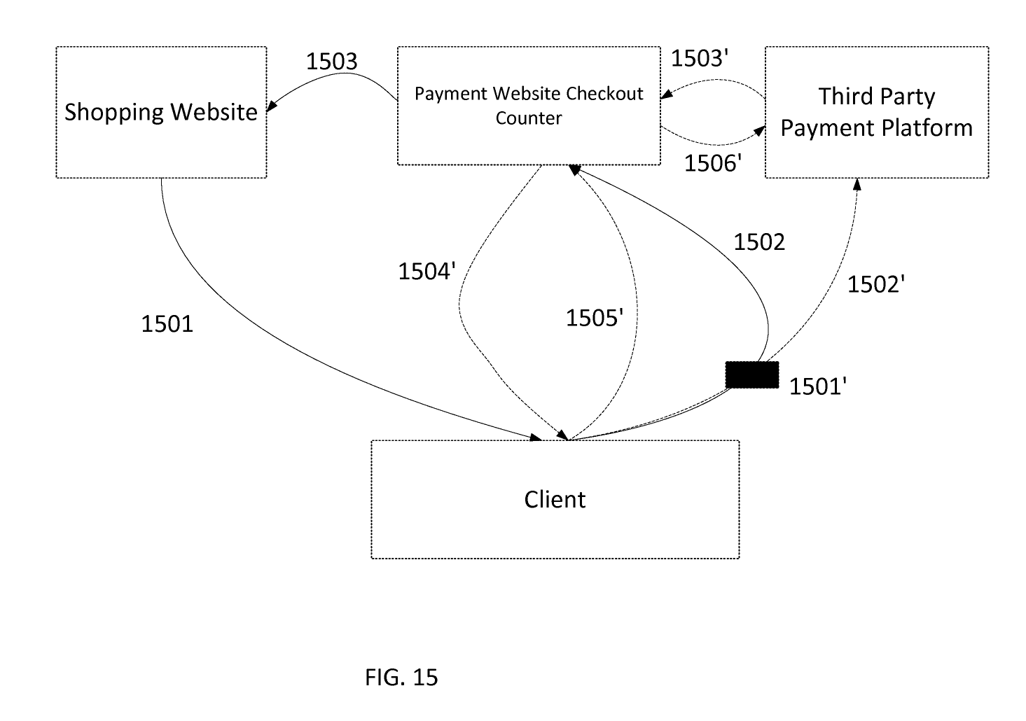

Referring to FIG. 15, for normal transactions, steps 1301, 1302 and 1303 of FIG. 13 correspond with steps 1501, 1502 and 1503 of FIG. 15. FIG. 15 illustrates an example of Trojan phishing where the Trojan horse goes to another third-party payment platform to generate an online banking recharge order while the user is at a payment website checkout counter. Thus, the user is tricked into making an online banking recharge payment. FIG. 15 illustrates a phishing to a third-party payment platform process.

In step 1501′, the user performs the recharge operation at the payment website checkout counter. For example, the user may purchase a product on a shopping website and enter the checkout counter in preparation for payment. The user initiates an “I want to pay” instantaneous payment transaction. The user clicks on the transaction details to complete payment. The Trojan horse monitors the URL address field of the browser. In response to the user preparing to make a payment, the Trojan horse intercepts the normal operating process.

In step 1502′, the Trojan horse directs the browser to another third-party payment platform and enters the account number of the swindler. The Trojan horse can use any of the following methods below to direct the browser to the third-party payment platform:

(1) The Trojan horse may modify the redirect address of the browser so that the browser is redirected to the third-party payment platform.

(2) The Trojan horse may modify the redirect address of the online banking order submission form. This approach varies slightly from the process illustrated in FIG. 15. The Trojan horse dynamically generates an order at a remote server and then remotely sends the order to the Trojan horse. The Trojan horse falsifies the form information in the web page. This approach was relatively common when Trojan horses first appeared.

(3) The Trojan horse may perform a large number of URL redirections in a relatively short period of time. For example, in the event the user activates the link for an online banking recharge, the Trojan horse does not directly intercept the link, but rather redirects the browser to the third party payment platform after the browser jumps to the online banking page.

In step 1503′, regardless of how many times the Trojan horse causes the browser to be redirected in step 1502′, the browser will go to a third-party payment platform and generate an online banking recharge order.

In step 1504′, the user sees in the browser that he or she now needs to pay an online banking order. The payment bank and amount will be the same as in a normal transaction process, but the recipient of the online banking recharge will not be the payment website. Instead, the recipient will be the account of the swindler.

In step 1505′, the user, not noticing the recharge payee being the account of the swindler, completes the recharge.

In step 1506′, the bank transfers the recharge funds into the account of the swindler. The phishing process ends.

As can be seen from the process above, Trojan phishing not only is related to payment website security, but is also related to the security of the phished third-party payment platform. This kind of Trojan horse may be prevented after the methods and systems of the present application are implemented and if the methods and systems of the present application are applied to third party payment platforms.

In summary, the present application includes at least the following advantages:

First, the present application achieves secure authentication of online transactions based on technologies such as, for example, OTP technology, password control technology, and transaction image signature technology. The present application also overcomes the limitations of hardware products. For example, the limitations of hardware products include scope of operation, service life, and technical upgrades.

Second, by using random session keys for secure communications of transaction images, the present application achieves double confirmation of user transactions. In other words, the present application implements second-generation OTP technology in software form to solve the existing problems software products have in preventing phishing, Trojan horses, and Trojan phishing.

Third, by establishing an OTP control server and an OTP authentication platform, the present application implements OTP technology batch transactions.

Fourth, the secure authentication system provided by the present application is implemented in software technology, which is easy to disseminate. If the present application can be implemented on third-party systems (such as third-party merchants or third-party payment platforms), the present application can boost the security of online transactions.

Each embodiment contained in present application is described in a progressive manner. The explanation of each embodiment focuses on areas of different from the other embodiments, and the descriptions thereof may be mutually referenced for portions of each embodiment that are identical or similar.

The online transaction secure authentication method and system described by the present application have been described in detail above. This document has employed specific embodiments to disclose the principles and forms of implementation of the present application. The above embodiments are only meant to aid in comprehension of the methods and the systems of the present application and of their core concepts. Moreover, a person of ordinary skill in the art would, on the basis of the present application, be able to make modifications for specific applications and to the scope of the applications. To summarize, the contents of the above disclosure should not be understood as limiting the present application, in any way.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A secure authentication method for online transactions, the method comprising:
generating, using one or more computer processors, a random session key to encrypt communications between a client and a server;
verifying a user identity of a user using the client based on the generated random session key;
in the event that the verification of the user identity is successful, generating transaction image information, encrypting the transaction image information based on the random session key, and transmitting the encrypted transaction image information to the client;
receiving a confirmation of the transaction image information, the confirmation comprising a transaction signature;
verifying the transaction signature based on the random session key.

2. A method as described in claim 1, wherein the generating of the random session key comprises:
receiving an encrypted random number that is generated by the client;
generating the random session key based on the encrypted random number; and
sending the random session key to the client.

3. The method as described in claim 1, wherein verifying of the user identity comprises:
receiving user machine information from the client; and
determining whether the user machine information matches previously stored user machine information to a predefined level.

4. The method as described in claim 3 further comprising:
generating a capture factor;
sending the capture factor to the client;
receiving the encrypted user machine information and the encrypted capture factor from the client;
decrypting the received capture factor and user machine information based on the ransom session key; and
determining the match level of the user machine information based on the received capture factor.

5. The method as described in claim 3 further comprising:
in the event the concluding of the user identity is unsuccessful verified, performing the following steps:
determining whether a mobile phone short-message send request is received from the client;
in the event the mobile phone short-message send request is received from the client, performing the following steps:
acquiring user information;
generating a mobile phone short-message verification code, and
sending the mobile phone short-message verification code to a mobile phone related to the client;
receiving the mobile short-message verification code from the client;
verifying the mobile short-message verification code; and
in the event the mobile short-message verification code is successfully verified, sending user identity verification successful result to the client.

6. The method as described in claim 1, wherein the generating of the transaction image information comprises:
generating a transaction verification code based on transaction information, the random session key, time, and user seed;
generating summary information based on the transaction information and the random session key;
generating a base image;
adding summary information to the base image; and
adding the transaction information and the transaction verification code to the base image to generate the transaction image information.

7. The method as described in claim 6, wherein the verifying of the transaction signature comprises:
receiving the transaction signature from the client;
verifying whether the transaction signature is correct; and
sending the verification result to the client.

8. An online transaction secure authentication system, the system comprising:
a one time password (OTP) control;
an OTP control server; and
an OTP authentication platform,
wherein:
the OTP control and OTP control server are configured to generate random session keys for encrypted communications between the OTP control and the OTP control server and verify user identity of the OTP control based on the random session keys; and
the OTP authentication platform:
is connected to the OTP control server,
generates transaction image information after receiving a user identity verification successful message sent by the OTP control server,
encrypts the transaction image information based on a random session key,
transmits the transaction image information to the OTP control, and
after the OTP control confirms the transaction image information, verifies a transaction signature based on the random session key.

9. A system as described in claim 8, wherein:
in the event the random session key is generated, the OTP control generates a random number, encrypts the random number based on a preset RSA public key, and sends the encrypted random number to the OTP control server, and
the OTP control server generates another random session key based on the encrypted random number and sends the other random session key to the OTP control.

10. A system as described in claim 8, wherein the verification of the user identity of the OTP control comprises:
the OTP control extracts user machine information, encrypts the user machine information based on the random session key, and sends the user machine information to the OTP control server;
the OTP control server verifies a match level of the user machine information;
in the event the match level of the user machine information exceeds a predefined threshold, the OTP control server sends a result indicating the user identity is successfully verified; and
in the event the match level of the user machine information falls below the predefined threshold, the OTP control server sends a result indicating the user identity is unsuccessfully verified.

11. A system as described in claim 10, wherein:
the OTP control server generates a capture factor and sends the capture factor to the OTP control;
the OTP control extracts user machine information based on the capture factor, uses the random session key to encrypt the user machine information and the capture factor, and sends the encrypted user machine information and capture factor to the OTP control server; and
the OTP control server verifies the match level of the user machine information based on the capture factor.

12. A system as described in claim 10, wherein in the event the user identity is unsuccessfully verified, the system comprises:
the OTP authentication platform acquires user information;
after receiving a mobile phone short-message send request, the OTP control server generates a mobile phone short-message verification code and sends the mobile phone short-message verification code to a mobile phone related to the OTP control;
the OTP control server verifies the short-message verification code; and
in the event verifying the short-message verification code is successful, the OTP control server sends a user identity verification successful result to the OTP control.

13. A system as described in claim 8, wherein the OTP authentication platform comprises:
an OTP algorithm driving module configured to generate a transaction verification code based on transaction information, the random session key, time, and user seed;
an OTP business system configured to generate summary information based on the transaction information and the random session key; and
an image server configured to generate a base image and add the summary information to the base image, and add the transaction information and transaction verification code to the base image containing the summary information to generate the transaction image information.

14. A system as described in claim 8, wherein:
in to the event the transaction signature is verified, the OTP control inputs the transaction verification code, digitally signs the transaction image information and the transaction verification code based on the random session key to create the transaction signature, and sends the transaction signature to the OTP authentication platform; and
the OTP authentication platform verifies whether the transaction signature is correct and sends a verification result to the OTP control.

15. A computer program product for secure authentication of online transactions, the computer program product being embodied in a non-transitory computer readable storage medium and comprising computer instructions for:
generating, using one or more computer processors, a random session key to encrypt communications between a client and a server;
verifying a user identity of a user using the client based on the generated random session key;
in the event that the verification of the user identity is successful, generating transaction image information, encrypting the transaction image information based on the random session key, and transmitting the encrypted transaction image information to the client;
receiving a confirmation of the transaction image information, the confirmation comprising a transaction signature;
verifying the transaction signature based on the random session key.

16. The computer program product as described in claim 15, wherein the generating of the random session key comprises:
receiving an encrypted random number that is generated by the client;
generating the random session key based on the encrypted random number; and
sending the random session key to the client.

17. The computer program product as described in claim 15, wherein verifying of the user identity comprises:
receiving user machine information from the client; and
determining whether the user machine information matches previously stored user machine information to a predefined level.

18. The computer program product as described in claim 17 further comprising:
generating a capture factor;
sending the capture factor to the client;
receiving the encrypted user machine information and the encrypted capture factor from the client;
decrypting the received capture factor and user machine information based on the ransom session key; and
determining the match level of the user machine information based on the received capture factor.

19. The computer program product as described in claim 17 further comprising:
in the event the concluding of the user identity is unsuccessful verified, performing the following steps:
determining whether a mobile phone short-message send request is received from the client;
in the event the mobile phone short-message send request is received from the client, performing the following steps:
acquiring user information;
generating a mobile phone short-message verification code, and
sending the mobile phone short-message verification code to a mobile phone related to the client;
receiving the mobile short-message verification code from the client;
verifying the mobile short-message verification code; and
in the event the mobile short-message verification code is successfully verified, sending user identity verification successful result to the client.

20. The computer program product as described in claim 15, wherein the generating of the transaction image information comprises:
generating a transaction verification code based on transaction information, the random session key, time, and user seed;
generating summary information based on the transaction information and the random session key;
generating a base image;
adding summary information to the base image; and
adding the transaction information and the transaction verification code to the base image to generate the transaction image information.

21. The computer program product as described in claim 20, wherein the verifying of the transaction signature comprises:
receiving the transaction signature from the client;
verifying whether the transaction signature is correct; and
sending the verification result to the client.

22. An online transaction secure authentication client, the client comprising:
at least one processor configured to:
receive a random session key to encrypt communications between the client and a server;
encrypt user machine information of a user based on the received random session key;
send the encrypted user machine information to the server;
receive encrypted transaction image information from the server;
encrypt a confirmation of the transaction image information; and
send the confirmation of the transaction image information to the server; and
a memory coupled with the processor, wherein the memory provides the processor with instructions.

23. The client as described in claim 22, wherein the receiving of the random session key comprises:
generating a random number;
encrypting the random number based on a preset RSA public key; and
sending the encrypted random number to the server.

24. The client as described in claim 22, wherein the encrypting of the user machine information comprises:
extracting the user machine information of the user; and
encrypting the user machine information based on the random session key.

25. The client as described in claim 24, wherein extracting of the user machine information comprises:
receiving a capture factor from the server;
extracting the user machine information relating to the received capture factor;
encrypting the user machine information based on the random session key; and
sending the encrypted user machine information to the server.

26. The client as described in claim 22, wherein the at least one processor is further configured to:
send a mobile phone short-message send request to the server;
receive a mobile phone short-message verification code from the server;
send the mobile short-message verification code to the server; and
receive a user identity verification successful result from the server.
